(19) United States
(12) Patent Application Publication
(10) Pub. No.: US 2015/0100902 A1
(43) Pub. Date: Apr. 9, 2015

(54) INFORMATION PROCESSING DEVICE, METHOD, AND PROGRAM

(71) Applicant: NEC Personal Computers, Ltd, Tokyo (JP)

(72) Inventors: Yoichiro Yamanaka, Tokyo (JP); Shizuka Ishikawa, Tokyo (JP)

(73) Assignee: NEC Personal Computers, Ltd, Tokyo (JP)

(21) Appl. No.: 14/509,626

(22) Filed: Oct. 8, 2014

(30) Foreign Application Priority Data
Oct. 8, 2013 (JP) 2013-210930

(51) Int. Cl. G06F 3/0488; G06F 3/0484; G06F 3/0481

(52) U.S. Cl. CPC G06F 3/04886; G06F 3/04812; G06F 3/04847; G06F 3/04883
USPC 715/761

(57) ABSTRACT

In a case that a part of the region of a touch panel is used as a touchpad, even when the touch panel screen is not watched, degradation of operability can be avoided. An information processing device includes: touch panel control means of performing control of displaying a virtual touchpad in a first region serving as a part of an entire display region of a touch panel; pointer operation input receiving means of receiving input of user operation to the first region, as input of operation of a pointer; and pointer display control means of, on the basis of the input of operation of the pointer, performing control of displaying a pointer on a display screen of an external display. Then, in a case that the input of user operation is stroke and that the start point of the stroke is located inside the first region and the end point is located outside the first region, the touch panel control means performs control of moving the first region such as to contain the end point.

### BACKGROUND OF THE INVENTION

1. Field of the Invention

The present invention relates to an information processing device, a method, and a program and, in particular, to those displaying a screen of an application onto an external

display.

2. Related Art

Patent Document 1 discloses a technique that the entire region of the plane on the near side relative to the keyboard of a notebook computer is constructed as a touch panel and then a part of the region is used as a touch pad. Patent Document 2 is regarded as disclosing a touchpad in which a region used as a pointing device can be changed arbitrarily.

Patent Document 1 Japanese Patent Laid-Open Publication No. 2010-066915

Patent Document 2 Japanese Patent Laid-Open Publication No. 2002-1.49338

### SUMMARY OF THE INVENTION

It is regarded that, description relevant to a technique that a part of the region of a touch panel is used as a touchpad is disclosed in Patent Documents 1 and 2. In the above-mentioned prior art, a region other than the set-up region cannot be used as a pointing device. Here, in a case that the touchpad is to be used in a state that the touch panel screen is not watched, immediately when the part pointed with the finger goes outside the region, the function as the touchpad is lost. This situation is inconvenient.

The present invention has been devised in view of the above-mentioned situation. An object thereof is to provide a technique in which in a case that a part of the region of a touch panel is used as a touchpad, even when the touch panel screen is not watched, degradation of operability is avoided.

The present invention devised for achieving the above-mentioned object is characterized by an information processing device comprising: touch panel control means of performing control of displaying a virtual touchpad in a first region serving as a part of an entire display region of a touch panel; pointer operation input receiving means of receiving input of user operation to the first region, as input of operation of a pointer; and pointer display control means of, on the basis of the input of operation of the pointer, performing control of displaying a pointer on a display screen of an external display, wherein in a case that the input of user operation is stroke and that the start point of the stroke is located inside the first region and the end point is located outside the first region, the touch panel control means performs control of moving the first region such as to contain the end point.

According to the present invention, in a case that a part of the region of a touch panel is used as a touchpad, even when the touch panel screen is not watched, degradation of operability can be avoided.

### BRIEF DESCRIPTION OF THE DRAWINGS

FIG. 1 is a diagram showing an exemplary configuration of external appearance according to an embodiment of the present invention.

FIG. 2 is a block diagram showing an example of hardware and software configuration of an information processing device 100 shown in FIG. 1.

FIG. 3 is a functional block diagram according to the above-mentioned embodiment.

FIG. 4 is a diagram (part 1) showing an example of a display screen constructed according to the above-mentioned embodiment.

FIG. 5 is a flow chart showing a flow of touch panel control processing according to the above-mentioned embodiment.

FIG. 6 is a diagram (part 2) showing an example of a display screen constructed according to the above-mentioned embodiment.

### DESCRIPTION OF THE EMBODIMENTS

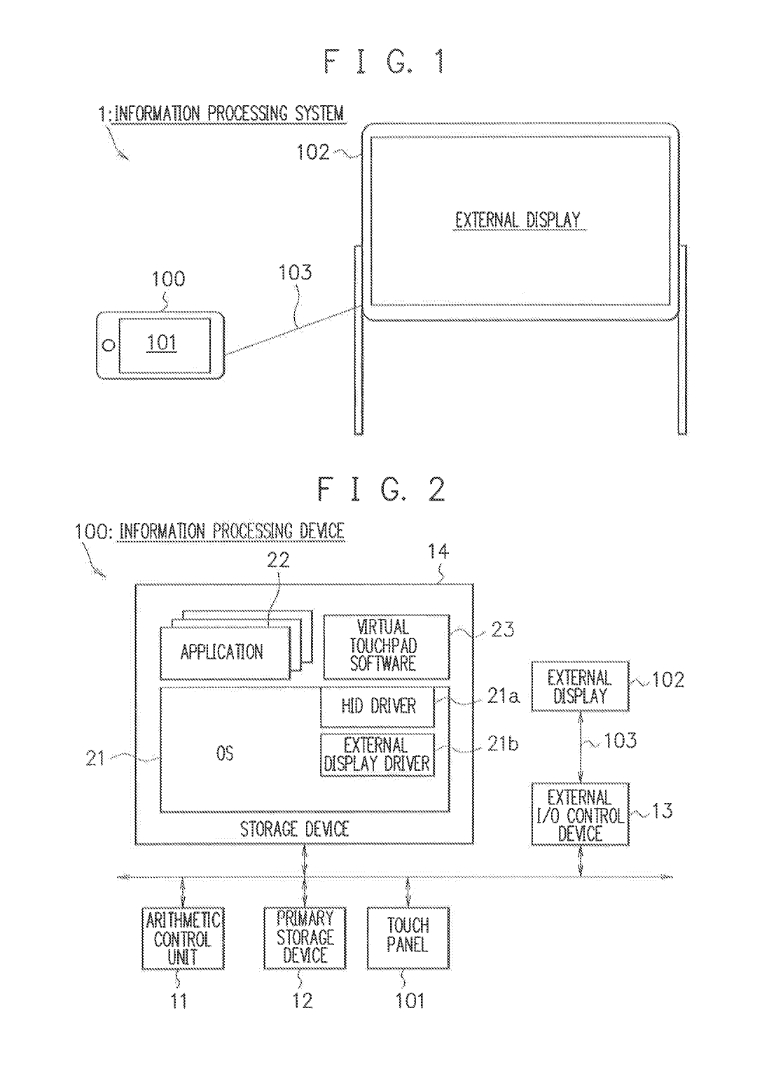

FIG. 1 shows an exemplary configuration of external appearance according to the present embodiment. As shown in the figure, an information processing system 1 according to the present embodiment may be constructed as a computer system including: an information processing device 100 constructed from a personal computer of tablet type (a tablet PC, hereinafter); and an external display 102. The type of display device employed in the external display 102 may be of diverse type such as a liquid crystal type and an organic electroluminescence type. The information processing device 100 and the external display 102 are connected in a manner of permitting mutual communication. Employable methods of communication are not limited to a particular one and the connection in the physical layer may be established, for example, through a display cable 103 as shown in the figure.

FIG. 2 shows an example of hardware and software configuration of the information processing device 100. In the information processing device 100, as the hardware, for example, a configuration may be employed that an arithmetic control unit 11, a primary storage device 12, an external I/O control device 13, a storage device 14, and a touch panel 101 are connected to each other through an internal bus. The external I/O control device 13 can perform input and output concerning the external display 102 through the display cable 103.

The storage device 14 stores a software program group used for perform information processing performed by the above-mentioned hardware. Such software includes an operating system (OS, hereinafter) 21, applications 22 which are various application software programs, and virtual touchpad software 23. As a part of the functions of the OS 21, a human interface device (HID, hereinafter) driver 21a and an external display driver 22b may also be included. The latter provides an interface used when the OS 21 operates the external display 102.

Here, the example of software configuration given above is an example adopted for description and may be modified variously. For example, the software may be provided by SaaS through a network. In the information processing achieved by the software program using the above-mentioned hardware, functional blocks described below are constructed. Further, the information processing is performed in accordance with a flow described later.

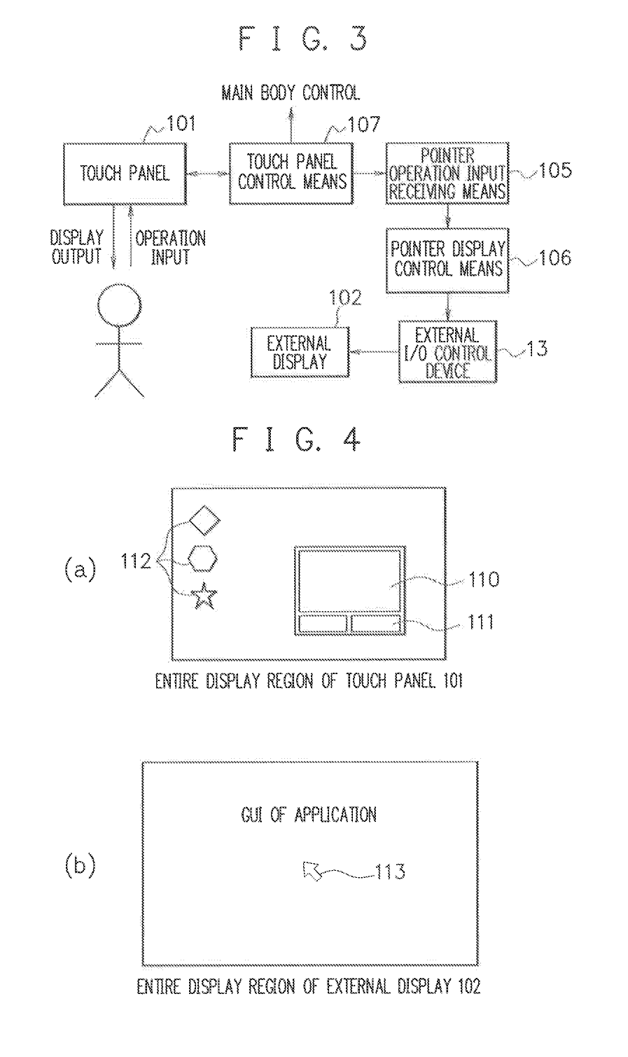

FIG. 3 shows a functional block diagram of the present embodiment. As shown in the figure, the information processing device 100 includes a touch panel 101, touch panel control means 107, pointer operation input receiving means 105, and pointer display control

means 106.

For example, the touch panel 101 is of electrostatic type and serves as display means as well as operation input means. FIG. 4 shows an example of a display screen according to the present embodiment. In the present embodiment, when the virtual touchpad software 23 is started, a virtual touchpad 110 shown in FIG. 4(a) is displayed on the touch panel 101. It is preferable that, as shown in FIG. 4(a), the virtual touchpad 110 is displayed such as to occupy a fixed area within the entire display region of the touch panel 101. Preferably, the virtual touchpad 110 includes function keys 111. The function keys 111 are used for right click and left click.

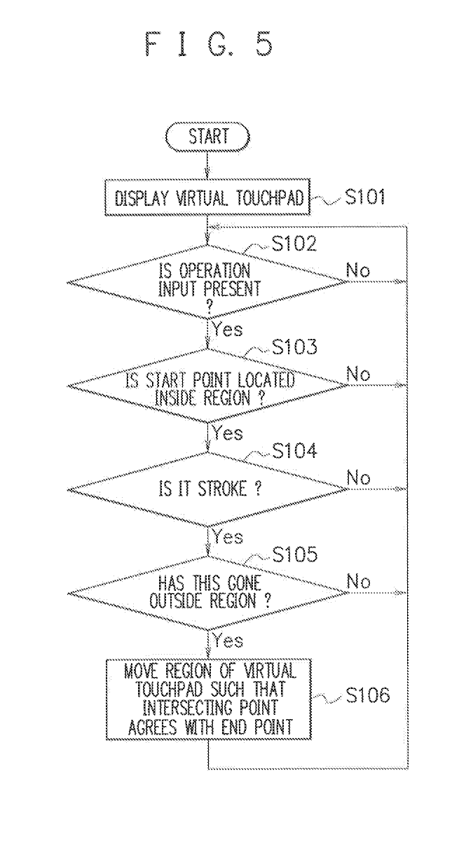

FIG. 5 shows a procedure of control performed by the touch panel control means 107. When the virtual touchpad software 23 is started, the touch panel control means 107 displays the virtual touchpad 110 in a part of the display region (S101). Thus, the screen shown in FIG. 4(a) is displayed and the screen shown in FIG. 4(b) is generated and displayed on the external display 102.

When the touch panel 101 has detected any operation input, operation input processing is started (S102). The touch panel control means 107 judges whether the operation input is that to the inside of the virtual touchpad 110. Here, preferably, the judgment criterion whether the operation input is that to the inside of the virtual touchpad 110 is such that when the start point of the operation input is located inside a predetermined region occupied by the virtual touchpad 110, it is judged as input to the inside of the virtual touchpad 110 (S103).

When the operation input is not operation input to the virtual touchpad 110, input information (such as coordinate information) thereof is outputted for the purpose of control in the information processing device 100 main body. When the operation input is operation input to the virtual touchpad 110, input information (such as coordinate information) thereof is outputted to the pointer operation input receiving means 105 for the purpose of control of the extended display utilization environment displayed on the external display 102. The pointer operation input receiving means 105 receives the input of user operation as input of operation of the pointer.

The pointer operation input receiving means 105 judges whether the operation input is tap. In case of not being tap, coordinate conversion is performed on the input coordinates such that the stroke may be reflected in the external display 102 at a predetermined magnification. The pointer display control means 106 generates a pointer image of the locus based on the converted coordinates and thereby performs display control.

Then, the touch panel control means 107 judges whether the operation input is tap, stroke, or the like. In particular, in the present embodiment, it is judged whether the operation input is stroke (S104). The stroke indicates operation input, in which detection of operation points on the touch panel 101 continues consecutively.

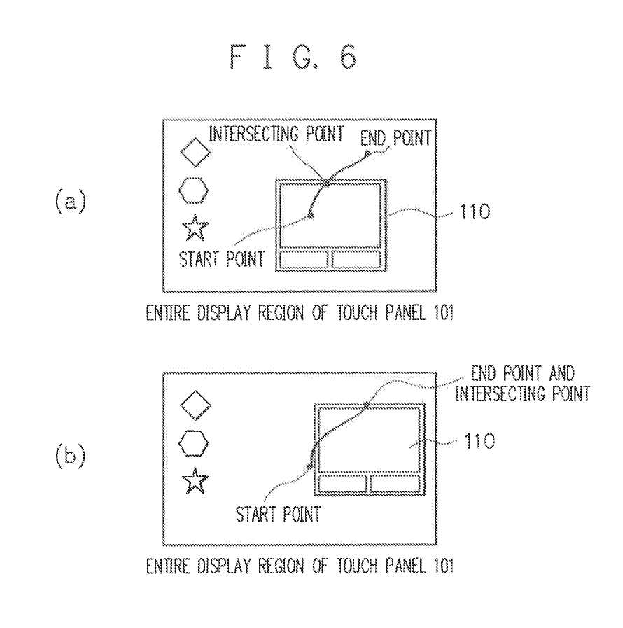

Then, the touch panel control means 107 detects whether the stroke whose starting point is located inside the virtual touchpad 110 region has gone outside the region (S105). FIG. 6(a) shows an example of a display screen of such a case. As shown in the figure, as a result of the stroke of this case, an intersecting point is formed between the stroke and the boundary line of the region of the virtual touchpad 110. The touch panel control means 107 stores the coordinates of the intersecting point into the primary storage device or the like.

Then, starting at a time point that the stroke goes outside the region of the virtual touchpad 110, the touch panel control means 107 continuously performs the control of moving the virtual touchpad 110 (S106). The destination of the movement is a position where the coordinates of the intersecting point become equal to the coordinates of the end point of the stroke.

By virtue of this control, as shown in FIG. 6(b), the region of the virtual touchpad 110 is moved in accordance with the input of user operation. Thus, in a case that a part of the region of a touch panel is used as a touchpad, even when the touch panel screen is not watched, degradation of operability can be avoided.

According to the present embodiment, in a region in which the pointer of the external display 102 can be operated, even when operation input tending to go outside the region is performed, the region is moved in accordance with the operation input such as to contain the end point of the operation input. By virtue of this, even when the user does not watch the display screen of the touch panel 101, an inconvenience is avoided that the pointer of the external display 102 suddenly becomes inoperable. Here, the processing of S106 may be performed at once after the stroke has been completed so that the end point has finally been fixed.

This application is based upon and claims the benefit of priority from Japanese patent application No. 2013-210930. filed on Oct. 8, 2013, the disclosure of which is incorporated herein its entirety by reference.

### DESCRIPTION OF REFERENCE NUMERALS

1 Information processing system
100 Information processing device (tablet PC)
101 Touch panel
102 External display
103 Display cable
104 Startup judging means
105 Pointer operation input receiving means
106 Pointer display control means
110 Virtual touchpad
111 Function key
112 Icons
113 Pointer

What is claimed is:

1. An information processing device comprising:
touch panel control means of performing control of displaying a virtual touchpad in a first region serving as a part of an entire display region of a touch panel;
pointer operation input receiving means of receiving input of user operation to the first region, as input of operation of a pointer; and
pointer display control means of, on the basis of the input of operation of the pointer, performing control of displaying a pointer on a display screen of an external display, wherein
in a case that the input of user operation is stroke and that the start point of the stroke is located inside the first region and the end point is located outside the first region, the touch panel control means performs control of moving the first region such as to contain the end point.

2. The information processing device according to claim 1, wherein the touch panel control means determines the moved position of the first region such that an intersecting point between the stroke and a boundary of the first region overlaps with the end point.

3. An information processing method comprising:
a first step of performing control of displaying a virtual touchpad in a first region serving as a part of an entire display region of a touch panel;
a second step of receiving input of user operation to the first region, as input of operation of the pointer;
a third step of, on the basis of the input of operation of the pointer, performing control of displaying a pointer on a display screen of an external display; and
a fourth step of, in a case that the input of user operation is stroke and that the start point of the stroke is located inside the first region and the end point is located outside the first region, performing control of moving the first region such as to contain the end point.

4. A program for causing a computer to execute:
first processing of performing control of displaying a virtual touchpad in a first region serving as a part of an entire display region of the touch panel;
second processing of receiving input of user operation to the first region, as input of operation of the pointer;
third processing of, on the basis of the input of operation of the pointer, performing control of displaying a pointer on a display screen of an external display; and
fourth processing of, in a case that the input of user operation is stroke and that the start point of the stroke is located inside the first region and the end point is located outside the first region, performing control of moving the first region such as to contain the end. point.
